(19) United States
(12) Patent Application Publication
(10) Pub. No.: US 2022/0282749 A1
(43) Pub. Date: Sep. 8, 2022

(54) SPLIT TYPE BOLT AND MANUFACTURING AND APPLICATION THEREOF

(71) Applicant: Xi'an University of Architecture and Technology, Xi'an City (CN)

(72) Inventors: Yong Yang, Xi'an City (CN); Shuchen Zhang, Xi'an City (CN); Xin Chen, Xi'an City (CN); Shiqiang Feng, Xi'an City (CN); Longkang Xu, Xi'an City (CN); Bin Liu, Xi'an City (CN)

(21) Appl. No.: 17/686,056

(22) Filed: Mar. 3, 2022

(30) Foreign Application Priority Data
Mar. 5, 2021 (CN) 202110246629.4

(51) Int. Cl. F16B 35/04; F16B 35/06

(52) U.S. Cl. CPC F16B 35/041; F16B 35/06

(57) ABSTRACT

A split type bolt includes a bolt cap and a screw rod. The bolt cap is composed of a plurality of bolt cap split parts, and the screw rod is composed of a screw rod base and a plurality of screw rod split parts. A gap is formed between adjacent bolt cap split parts and is filled with a filling material, and a gap is formed between adjacent screw rod split parts and is not filled. A method for manufacturing the split type bolt includes the steps of cutting an incomplete through gap from the bolt cap to the screw rod of a high strength bolt by a machine tool, and arranging the filling material in the through gap formed in the bolt cap.

### CROSS REFERENCE TO RELATED APPLICATION(S)

This patent application claims the benefit and priority of Chinese Patent Application No. 202110246629.4, filed on Mar. 5, 2021, the disclosure of which is incorporated by reference herein in its entirety as part of the present disclosure.

### TECHNICAL FIELD

The present disclosure belongs to the technical field of buildings, and in particular relates to a split type bolt and manufacturing and application thereof.

### BACKGROUND ART

The steel-concrete composite structure is widely applied to the engineering due to good mechanical property, convenient construction method and better comprehensive benefits thereof. The shear connector serves as a key component, the shear resistance of which directly affects the overall performance of the composite structure. As one of the important types of shear connectors, the high strength bolt has the advantages of being high in strength, high in stiffness, tight in connection, easy in installation, detachable, and is the preferred connector.

As a main form of the engineering structural connection, the bolted connection is widely used in field installation of the fabricated steel structure and the composite structure. However, the trend of high strengthening of building materials and assembly of the building structure has put forward higher requirements on the connection and joint performance. With the increasing application of high-strength steel and ultra-high-performance concrete in construction projects, the currently used shear connectors may not be able to bear the consequent increase in shear stress and is likely to suffer brittle damage.

### SUMMARY OF THE INVENTION

To overcome the defects in the prior art, an objective of the present disclosure is to provide a split type bolt and manufacturing and application thereof. The bolt has the features of high bearing capacity and good ductility, as well as the ability of meeting connection requirements of high-strength steel or ultra-high-performance concrete better.

To achieve the above objective, the technical solution adopted by the present disclosure is as follows:

A split type bolt comprises a bolt cap 11 and a screw rod 12, wherein the bolt cap 11 is composed of a plurality of bolt cap split parts 111, and the screw rod 12 is composed of a screw rod base 122 and a plurality of screw rod split parts 121, wherein a gap is formed between adjacent bolt cap split parts 111 and is filled with a filling material 2, and a gap is formed between the adjacent screw rod split parts 121 and is not filled.

In addition, the split type bolt provided by the present disclosure can also have the following additional technical features:

The gap penetrates to the upper end of the screw rod base 122 in the axial direction, and at an axial penetrating portion, the gap completely penetrates in the radial direction.

The gap has a width of 1-6 mm, and the screw rod base 122 has a height of 30-80 mm.

The screw rod 12 is a rod part which is partially unthreaded and partially threaded, or is a full threaded rod part.

The bolt cap split parts 111 and the screw rod split parts 121 are of an equal number and are correspondingly arranged, that is, a gap plane between the adjacent bolt cap split parts 111 and a gap plane between the adjacent screw rod split parts 121 are located in the same plane in a one-to-one correspondence mode.

The number of the bolt cap split parts 111 and the number of the screw rod split parts 121 are both two or four.

The filling material 2 is a steel sheet, a washer, or a building structure adhesive.

The split type bolt is a high strength bolt with a large hexagon head and the specification is M20 to M48.

The present disclosure further provides a manufacturing method of the split type bolt, which comprises the steps of cutting an incomplete through gap from the bolt cap 11 to the screw rod 12 of the high strength bolt by a machine tool, and arranging the filling material 2 in the through gap formed in the bolt cap 11.

The present disclosure further provides an application of the split type bolt, the screw rod base 122 penetrates a perforated steel plate 5 or a steel/concrete beam 6 and is fastened by a washer 3 and a nut 4.

Compared with the prior art, the present disclosure provides the following beneficial effects: 1) the plurality of split parts can make the split type bolt have excellent ductility, each split part is easier to bend and deform due to small stiffness, thus achieving the effect of high bearing capacity and good ductility, and better developing the performance of the structure; 2) the diameter of the bolt is greater than the specification of a commonly-used bolt specified in the regulation, the shear bearing capacity of the bolt connector is greatly improved by increasing the diameter of the screw rod, meanwhile, the requirement for shear force between the high-strength steel or ultra-high-performance concrete can be met by adopting the high strength bolts with a large hexagon head, thus meeting the strength requirement for the shear connector; and 3) the split type bolt provided by the present disclosure can be fastened to the perforated steel plate by the washer and the nut, thus the ductility is increased while the shear bearing capacity is improved.

In conclusion, the split type bolt provided by the present disclosure is excellent in mechanical property, easy and convenient in construction, convenient to dismount, and capable of meeting requirements for connection of high-strength steel or ultra-high-performance concrete better.

### BRIEF DESCRIPTION OF THE DRAWINGS

FIG. 1 is a diagram of a split type bolt provided by an embodiment of the present disclosure.

FIG. 2 is a front view of FIG. 1.

FIG. 3 is a diagram of a split type bolt and a steel-concrete composite beam in FIG. 1.

FIG. 4 is a diagram of a split type bolt in steel joint connection in FIG. 1.

FIG. 5 is a diagram of a second split type bolt provided by an embodiment of the present disclosure.

FIG. 6 is a front view of FIG. 5.

In the drawings: 1—split type bolt; 11—bolt cap; 111—bolt cap split part; 12—screw rod; 121—screw rod split part; 122—screw rod base; 2—filling material; 3—washer; 4—nut; 5—perforated steel plate; 6—steel or concrete beam.

### DETAILED DESCRIPTION OF THE EMBODIMENTS

In order to achieve the above objectives, the technical solutions, and advantages of the embodiments of the present disclosure more clearly, the following clearly and completely describes the technical solutions in the embodiments of the present disclosure with reference to the accompanying drawings in the embodiments of the present disclosure. The described embodiments are merely a part rather than all of the embodiments of the present disclosure. The components of the embodiments of the present disclosure, as generally described and illustrated in the accompanying drawings herein, could be arranged and designed in a wide variety of different configurations.

Therefore, the following detailed description of the embodiments of the present disclosure, as provided in the accompanying figures, is not intended to limit the scope of the present disclosure for which the protection is claimed, but merely indicates selected embodiments of the present disclosure. All other embodiments obtained by those of ordinary skill in the art based on the embodiments of the present disclosure without creative efforts shall fall within the protection scope of the present disclosure.

It should be noted that like reference numerals and letters in the following accompanying drawings indicate similar items, and thus, once a certain item is defined in one accompanying drawing, it does not need to be further defined and explained in the following accompanying drawings.

In the description of the present disclosure, it is noted that orientation or positional relationship indicated by the terms “up”, “down”, and the like is based on the orientation or position relationship shown in the accompanying drawings, or the orientation or positional relationship of the product which is usually placed when the product is used, and is only for convenience of description of the present disclosure and simplification of description rather than indicating or implying that the apparatus or element referred to must have a particular orientation, be constructed and operate in a particular orientation, and thus is not to be construed as a limitation of the present disclosure.

### Embodiment 1

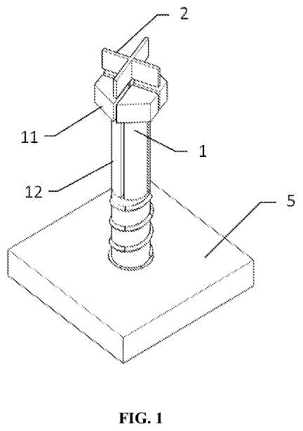

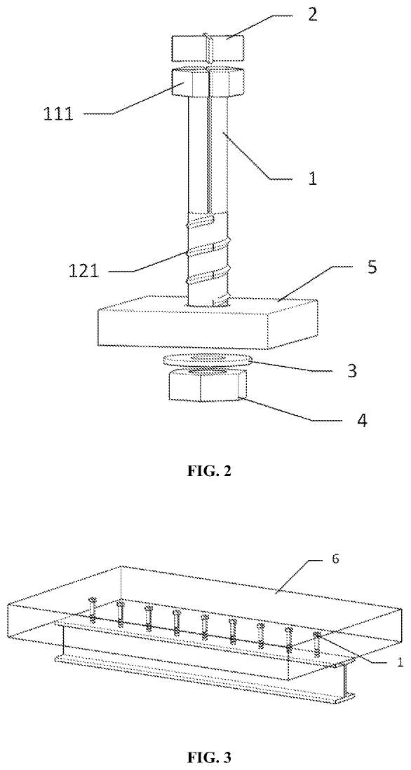

Referring to FIG. 1, an embodiment of the present disclosure provides a split type bolt 1, comprising a bolt cap 11 and a screw rod 12, wherein the bolt cap 11 is composed of a plurality of bolt cap split parts 111, and the screw rod 12 is composed of a screw rod base 122 and a plurality of screw rod split parts 121, wherein a gap is formed between adjacent bolt cap split parts 111 and is filled with a filling material 2, and a gap is formed between adjacent screw rod split parts 121 and is not filled. In the embodiment, the filling material is a steel sheet.

During application, the split type bolt 1 is connected to a perforated steel plate 5 by a washer 3 and a nut 4.

The plurality of split parts can make the split type bolt 1 have good ductility; each split part is easier to bend and deform due to small stiffness, thus achieving the effect of high bearing capacity and good ductility, and better developing the performance of the structure. The shear bearing capacity of the bolt connector is greatly improved by increasing the diameter of the screw rod 12, thus meeting the requirement for the shear force between the high-strength steel or ultra-high-performance concrete.

In the embodiment, the split type bolt 1 employs a high strength bolt with a large hexagon head and the specification is M20 to M48, which can meet the strength requirement of a shear connector. The bolt cap 11 and the screw rod 12 are made of 20MnTiB, ML20MnTiB or 35Vb. The washer 3 and the nut 4 are made of 45#, 35#, or ML35. The perforated steel plate 5 is made of Q235, Q345, Q420, or Q690.

In the embodiment, the split type bolt 1 is manufactured by cutting an incomplete through gap from the bolt cap 11 to the screw rod 12 of the high strength bolt by a machine tool.

In the embodiment, the bolt cap 11 and the screw 12 are subjected to gap-cut by means of a numerically controlled plasma cutter or the like, thus forming a plurality of bolt cap split parts 111 and a plurality of screw rod split parts 121, wherein an uncut part is left as the screw rod base 122. The gap has a width of 1-6 mm, and the screw rod base 122 has a height of 30-80 mm.

Specifically, the gap penetrates to the upper end of the screw rod base 12 in the axial direction and penetrates through the bolt at the penetrating portion in the radial direction. On the premise of meeting the use requirements, such design facilitates the filling of the gap between of the bolt cap split parts 111 with the material. In the embodiment, the gap between the bolt cap split parts 111 can be filled with the steel sheet, the washer, or a building structure adhesive.

For example, FIG. 1 illustrates a split type bolt 1 with the bolt specification of M22. The split type bolt is cut into four split parts with the cut gap width of 2 mm, and an uncut region (a screw rod base 122) is left at the bottom of the screw rod, and the gap is filled with the steel sheet.

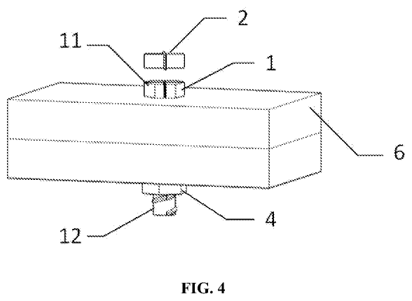

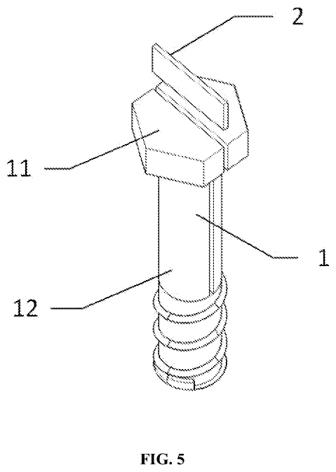

For example, FIG. 4 illustrates a second split type bolt 1 with the bolt specification of M24. The split type bolt is cut into two split parts with the cut gap width of 2 mm, and an uncut region (a screw rod base 122) is left at the bottom of the screw rod, and the gap is filled with the steel sheet.

The shearing strength of the split type bolt is improved due to the fact that the diameter of the screw rod 12 is increased in comparison with the diameter of the common screw rod, and due to the bending and deformation of each split part, good ductility can be maintained while the shear bearing capacity is improved. Therefore, the split type bolt is applicable to a composite structure of the high-strength steel and the high-strength concrete (such as, to form the structure illustrated in FIG. 3) or steel joints (such as, to form the structure illustrated in FIG. 4.) That is, the diameter of the split type bolt 1 is greater than the specification of the commonly-used bolt specified in the regulation. Thus, the shearing strength of the split type bolt can be greatly improved; and due to the design of the split parts, the whole ductility of the split type bolt 1 can be maintained after the diameter is enlarged.

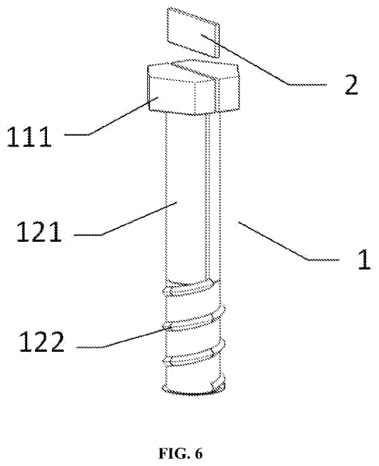

Meanwhile, the number of the split parts can be chosen to be two (e.g., the second split type bolt illustrated in FIG. 5 and FIG. 6) or four (e.g., a split type bolt illustrated in FIG. 1). The split parts can make the split type bolt 1 retain the ductility.

The screw rod 12 of the split type bolt 1 can be a rod part which is partially unthreaded and partially threaded, or is a full threaded rod part.

After completing the machining, the split type bolt 1 is fastened to the perforated steel plate 5 by the washer 3 and the nut 4. The hole diameter of the perforated steel plate is a standard circular hole which conforms to the regulation of hole forming allowable deviation of high strength bolt connecting element in JGJ82-2001 Technical Regulations for High strength bolt Connection of Steel Structures. A torque wrench is adopted in the bolted connection, which is used to regulate a torque first and then fasten the bolt. The bolted connection is simple in operation, time-saving and labor-saving, and convenient for construction.

The split type bolt 1 in the embodiment not only can be used for joint connection of a steel structure, but also can be used as a connector for the steel-concrete composite structure, with high shear bearing capacity and good ductility; and meanwhile, the number of the bolts can be reduced, the operation is simple and fast, the dismounting is convenient, and the construction is flexible.

In conclusion, in accordance with the split type bolt 1 provided by the present disclosure, each split part is easier to bend and deform due to small stiffness, thus maintaining good ductility. The split type bolt 1 is fastened to the perforated steel plate 5 by the washer 3 and the nut 4. The ductility is increased while the shear bearing capacity is improved, thus better developing the performance of the structure and better satisfying the requirement for the connection of the high-strength steel or ultra-high-performance concrete.

The above is only a preferred embodiment of the present disclosure and is not intended to limit the present disclosure. Various changes and variations can be made to the present disclosure for those skilled in the art. Any modifications, equivalent substitutions, improvements and the like made within the spirit and principles of the present disclosure shall be included in the scope of protection of the present disclosure.

What is claimed is:

1. A split bolt, comprising:
a bolt cap (11); and
a screw rod (12), wherein the bolt cap (11) is composed of a plurality of bolt cap split parts (111), and the screw rod (12) is composed of a screw rod base (122) and a plurality of screw rod split parts (121), wherein a first gap is formed between adjacent bolt cap split parts (111) and is filled with a filling material (2), and a second gap is formed between adjacent screw rod split parts (121) and is not filled.

2. The split type bolt according to claim 1, wherein the first gap penetrates to an upper end of the screw rod base (122) in an axial direction, and at an axial penetrating portion, the first gap completely penetrates in a radial direction.

3. The split type bolt according to claim 1, wherein the first gap has a width of 1-6 mm, and the screw rod base (122) has a height of 30-80 mm.

4. The split type bolt according to claim 1, wherein the screw rod (12) is a rod part which is partially unthreaded and partially threaded, or is a threaded rod part.

5. The split type bolt according to claim 1, wherein the bolt cap split parts (111) and the screw rod split parts (121) are of an equal number and are correspondingly arranged, wherein a first gap plane between the adjacent bolt cap split parts (111) and a second gap plane between the adjacent screw rod split parts (121) are located in a same plane in a one-to-one correspondence mode.

6. The split type bolt according to claim 1, wherein a number of bolt cap split parts (111) and a number of screw rod split parts (121) are both two or four.

7. The split type bolt according to claim 5, wherein a number of bolt cap split parts (111) and a number of screw rod split parts (121) are both two or four.

8. The split type bolt according to claim 1, wherein the filling material (2) is selected from a group consisting of a steel sheet, a washer, and a building structure adhesive.

9. The split type bolt according to claim 1, wherein the split type bolt is a high strength bolt with a large hexagon head and a specification is M20 to M48.

10. A method of manufacturing the split type bolt according to claim 1, comprising steps of:
cutting an incomplete through gap from the bolt cap (11) to the screw rod (12) of a high strength bolt by a machine tool; and
arranging the filling material (2) in the through gap formed in the bolt cap (11).

11. Use of the split type bolt according to claim 1, wherein the screw rod base (122) penetrates a perforated steel plate (5) or a steel/concrete beam (6) and is fastened by a washer (3) and a nut (4).
